(19) United States
(12) Patent Application Publication
(10) Pub. No.: US 2004/0036604 A1
(43) Pub. Date: Feb. 26, 2004

(54) Capacitive alarm system

(76) Inventors: Goran Hansson, Uppsala (SE); Tommy Soderberg, Bandhagen (SE); Bo Lindgren, Enskede (SE); Stig Norberg, Jarfalla (SE)

Correspondence Address: YOUNG & THOMPSON, 745 SOUTH 23RD STREET 2ND FLOOR, ARLINGTON, VA, 22202

(21) Appl. No.: 10/363,560

(22) PCT Filed: Sep. 6, 2001
(86) PCT No.: PCT/SE01/01907

(30) Foreign Application Priority Data
Sep. 6, 2000 (SE) 0003165-8

(51) Int. Cl. G08B 13/26

(52) U.S. Cl. 340/562

(57) ABSTRACT

An alarm system for surveillance of a container located within an electric or electromagnetic field surrounding the container includes a detector device which comprises generating elements for generating an electric or electromagnetic field, balancing elements for building up a balanced electric or electromagnetic field, filtering elements to prevent the detector device from being affected by chances in temperature and humidity. The container includes conductive material and connected to the detector device so as to constitute an antenna for sensing small capacitive changes in the electric or electromagnetic field. The generating and balancing elements respectively generate and build up an electric or electromagnetic field around the container.

### TECHNICAL FIELD

This invention relates to an alarm system for use with a conductive container which uses a capacitive detector with an antenna for detecting small capacitive changes in an electric or electromagnetic field surrounding the antenna.

### BACKGROUND OF THE INVENTION

The method of measuring changes in an electric or electromagnetic field in order to detect intruders is widely used in different kind of alarm systems. The object of such alarm systems is to protect an area from intruders or an object from being removed or stolen. These alarms have often 1 field and causes two modes—alarm or not alarm, typically give some kind of a first warning when a change in the electric or electromagnetic field occurs, i.e. they act to prevent the intruder from even getting close to the object or area being protected. However, these systems have many disadvantages that often trigger false alarms. Some of the disadvantages are:

1) The use of an oscillator which operates at high frequencies often in the RF range. The problem with high frequencies is that they do not meet the requirements in the legislation concerning EMC (Electro Magnetic Compatibility), i.e. they interfere with other electronic equipment such as mobile telephones, TV and radio.

2) Sensitivity to changes in humidity which can trigger false alarms if the detector or sensor is set to detect small changes.

3) Difficulty in defining a balanced field surrounding the antenna, due to different conductive objects in the proximity to the antenna that distort the propagation of the detector field in space.

4) Drifting of various electronic elements and circuits due to changes in temperature which will affect the detecting accuracy.

WO 88/08595 discloses a capacitance proximity sensor which uses a conducting foil as a sensing electrode. The conducting foil is connected to an electronic circuitry. The electronic means comprises an inductive coil which together with the configuration of the conducting foil controls the frequency of an oscillator, typical 80 kHz. The presence of an intruder in the field changes the capacitance of conducting foil and alters the oscillator frequency. This frequency change is used to detect a capacitive change. This capacitance proximity sensor operates with a frequency of 80 kHz which results in one of the above mentioned problems, i.e. it will not meet the EMC requirements.

U.S. Pat. No. 4,987,402 discloses an alarm system which uses a proximity detector to detect an intrusion into an adjustable electromagnetic field set up around the object to be protected. This electromagnetic field is a RF field which results in the above mentioned problem.

EP 0 334 531 discloses a proximity detector made up of conductive paint and with a capacitor and switching means that form a an oscillator having a frequency of from 1 to 150 kHz. This detector measures the frequency change when an intruder enters the field. This detector, since using paint as an electrode, is directed toward surveillance of rooms or doorways and its application has therefore a very narrow range.

As regards containers such as safes, an increased safety could be obtained against break-in or unauthorised removal if the action could be detected before it was physically done. If the attacker has unlimited time and can work undisturbed, almost any safes may be broken into. Alternatively, the attacker may remove the safe to a place where the attack may be done undisturbed.

Many of the sensors used for detecting an attack, such as magnetic breakers or thermal detectors react when an attempt on breaking in already is taking place. Other sensors such as level indicators, vibration alarms or sound sensors, need to have their settings such that only very powerful disturbances trigger an alarm, due to risks of false alarms in disturbing environments.

Some methods try to detect an attack at an early stage. The method disclosed in document U.S. Pat. No. 4,169,260 has the drawback that the propagation of the signal is not limited. If the safe for example is placed against a thin wall, movements on the other side of the wall will be detected and cause false alarms.

For capacitive methods using amplitude or frequency modulation, there is further a risk for attacks with frequency generators or other signal generators.

When using capacitive detection systems in this application, there would be an advantage if also the presence of non-conductive objects, such as a sledge hammer with a wooden handle or a rubber sledge hammer, could be detected.

In all, the above mentioned drawbacks lead to complicated compensation designs, and in turn to high manufacturing costs.

### BRIEF DESCRIPTION OF THE INVENTION

The object of the present invention is to provide a surveillance and alarm system for metallic containers which is capable of providing several levels of safety as regards how close to the container a person i present, where the container itself constitutes all or a part of a balanced antenna signal, and wherein the container as well as the antenna signal surrounds the alarm electronics.

The capacitive detector used with the present invention is capable of generating a balanced field surrounding the container and which is not affected by changes in humidity and temperature or manipulated through a frequency generator in order to detect small capacitive changes in the generated field surrounding the container.

The alarm system is realized with a container connected to an electronic circuitry, wherein the container constitutes the antenna, which generates an electric field around the container. The electronic circuitry comprises, generating means for generating an electric or electromagnetic field around said container, adjustable means for building up a balanced electric field around the container, balancing means for maintaining the generated electric or electromagnetic field around said container balanced, filtering means which prevents the detector device from being affected by changes in temperature and humidity, detection means which detects small changes in the generated electric field around said container, and indicating means which indicates that a change in the generated electric field has occurred.

One preferred embodiment of the capacitive detector comprises an alarm system capable of generating different alarm signals depending on how close the intruder is to the container being protected.

Further, the present invention preferably detects and alarms any attempts of attacks on for example a safety cabinet by non-conductive objects in that the invention registers that the relation between any of the factors signal-/reference antenna or ground is altered or loss of the antenna. The present invention also detects any intrusions when the door of the container is open by the extended protection field due to the enlarged antenna.

These and further objects of, and advantages with, the present invention will become apparent from the following detailed description and from the accompanying drawings.

### BRIEF DESCRIPTION OF THE DRAWINGS

The above and other features and advantages of the present invention will become apparent from the following detailed description of the preferred embodiments, given by a way of example, taken in conjunction with the accompanying drawings in which:

FIG. 1 is a circuit diagram of a first embodiment having an analogue capacitive detector circuitry according to the present invention;

FIG. 2 is a circuit diagram of a second embodiment having a partly microprocessor capacitive detector based architecture according to the present invention;

FIG. 3 is a view showing the capacitive detector arranged in a safe;

FIG. 4 shows a detailed view from the side of a detecting device capable of detecting attacks with non-conductive objects;

FIG. 5 shows a view from above of the device of FIG. 4; and

FIG. 6 shows a view from above of a safe with open door.

### DETAILED DESCRIPTION OF THE INVENTION

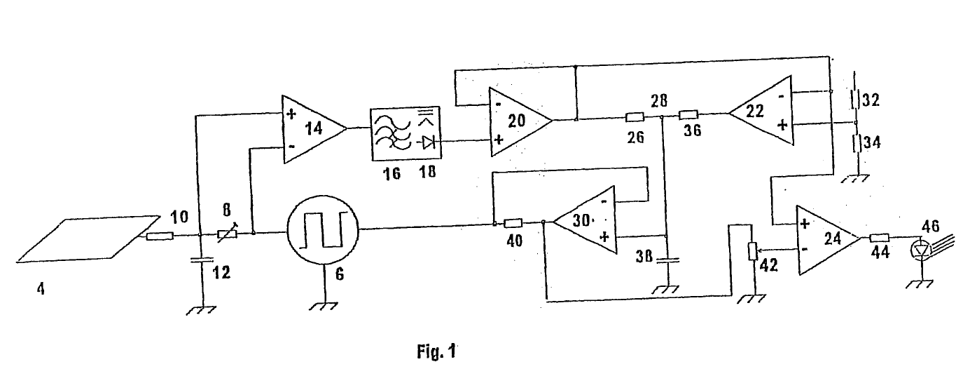

FIG. 1 shows an electronic circuitry 2 and an antenna 4 that constitute one preferred embodiment of the capacitive detector to be used with the present invention.

The electronic circuitry 2 has a square wave generator 6 which has one output terminal connected to ground and the other output terminal connected to an adjustable resistor 8. This other output terminal is also connected to the negative input of an operational amplifier 14. The other end of the adjustable resistor is connected to a low-pass filter comprising a resistor 10 and a capacitor 12 and to the positive input of the operational amplifier 14. The capacitor 12 of the low-pass filter is connected to ground and the resistor 10 is connected to the antenna 4. The output of the operational amplifier 14 is connected via a high-pass filter 16 and a peak value rectifier 18 to the positive input of an operational amplifier serving as a voltage follower 20. The output of the voltage follower 20 is used as feedback to the negative input thereof. The output of the voltage follower 20 is also connected to the negative input of a comparator 22, to the positive input of a comparator 24 and via a resistor 26 and a summation node 28 to the positive input of a voltage follower 30. The positive input of the comparator 22 is supplied by a reference voltage from a voltage divider comprising to resistors 32 and 34. Resistor 32 is connected to a positive supply voltage and the resistor 34 is connected to ground. The output of the comparator 22 is via resistor 36 and the summation node 28 connected to the positive input of the voltage follower 30. The summation node 28 is connected to ground via a capacitor 38. The output of the voltage follower 30 is via a resistor 40 used as feedback to the negative input thereof. This output is also used via the resistor 40 as an input to the square wave generator 6 which thereby closes the loop. The direct output of the voltage follower 30 is via a potentiometer 42 used as a negative input to the comparator 24. The output of the comparator 24 is via a resistor 44 connected to a light emitting diode 46, LED, which is connected to ground.

Thus, the physical constitution of the capacitive detector has been described and the description will now be directed toward the function of the different elements in the electronic circuitry 2 constituting the capacitive detector.

The configuration of the antenna 4 can be varied in numerous different ways depending on the application of the capacitive detector. One example will be given below in conjunction with the description of an alarm system according to the present invention.

The square wave generator 6, the output level of which is adjustable, generates a square wave, 50-5000 Hz, which is applied to the antenna 4 via the adjustable resistor 8 and the low-pass filter 10, 12. The applied square wave generates an electrical field around the antenna 4. The capacitive load caused by the surrounding ground structure on the antenna 4 is typically around 50-500 pF.

The object of the adjustable resistor 8 is to interface the square wave to the conditions given by the specific surroundings in order to establish a balanced operating point at the output of the voltage follower 20. This balanced operating point is used as reference in comparison with quick changes in the electric field, which will trigger the LED 46. The adjustable resistor 8 is initially set such that the operating point at the output of the voltage follower 20 is equal to the reference voltage applied to the comparator 20 by the voltage divider 32, 34. The adjustable resistor 8 could also be realized as a digitally controlled resistor if the capacitive detector is to be realized in a microcomputer architecture, which will be described below.

The low-pass filter 10, 12 is used to stabilize and balance the electric field generated around the antenna 4 and to prevent RF signals from being input to the electric circuitry 2, which otherwise could cause interference. As an option an inductor (not shown) could be connected in series with the resistor 10 if that is required to stabilize and balance the electric field around the antenna 4.

The operational amplifier 14, which on its negative input is supplied with the square wave generated by the square wave generator 6 and on its positive input is supplied with the square wave affected by the capacitive load on the antenna 4, amplifies the difference thereof. The operational amplifier 14 works with a gain around 300 000, i.e open loop gain. This is necessary in order to detect small changes in the generated capacitive field. The operational amplifier 14 has among other parameters the Common Voltage Mode Range, CVMR. The CVMR defines the +/− operating range within which the input signal has to be in order to be linearly amplified. If the input signal is outside this CVMR the operational amplifier 14 is blocked and the output will either go high or low. By balancing the variable high level of the generated square wave such that it precisely is kept within the CVMR the unnecessary parts of the signal is blocked away and thus only a small portion of the square wave gets amplified. This portion has the greatest sensitivity regarding capacitive influence. The capacitive influence on the signal coming from the antenna 4 has the typical form of a discharge curve. The differential measurement performed by the operational amplifier 14 measures the difference between the unaffected square wave and the by the antenna capacitive affected square wave. Since the component values in the electronic circuitry are very important for balancing the operational amplifier 14 correct they are listed in a separate component list following the description.

The high-pass filter 16 is used to filter DC components. This is done to eliminate the effect of temperature and humidity changes that may affect the accuracy of the capacitive measurement.

The voltage follower 22 is used to separate the detector part of the circuitry 2 from the subsequent circuits. This is done to limit the influence of the subsequent circuits on the peak value rectifier 18. The voltage follower 30 is also used to limit the influence of the subsequent circuits thereof on the capacitor 38 and resistors 26 and 36.

The comparator 22 is used to stabilize and balance the square wave generator 6. The voltage divider 32, 34 supplies the comparator 22 with the reference voltage, which is to be compared with the output of the voltage follower 20. The output of the comparator 22 generates a reverse polarity compared to changes in the voltage follower 20 output. The capacitor 38 is provided to prevent oscillation of the comparator 22, i.e. the regulation will be attenuated by a time constant R*C, where C is the value of capacitor 38 and R is the value of the resistor 36.

The comparator 24 is used to detect changes in the generated electric field surrounding the antenna 4. These capacitive changes typically have a value of 2-10 pF when a human body enters the electric field. The positive input of the comparator 24 is the output from the voltage follower 20. Under normal circumstances, i.e. when no changes in the electric field occur, this positive input corresponds to the reference voltage. The negative input of the comparator 24 is supplied via potentiometer 42 from the output of the voltage follower 30, which also corresponds to the reference voltage. The potentiometer 42 is used to set the level at which the capacitive detector shall indicate that there has been a change in the electric field, for instance when an intruder gets closer to the antenna 4 than a predetermined distance. To indicate that this has happened the comparator 24 output goes high which activates the LED.

Thus the principles of the capacitive detector have been described. The described embodiment is made up of analogue circuits, but could of course by those skilled in the art be realized with a microcomputer based architecture or other architectures without departing from the scope of the invention.

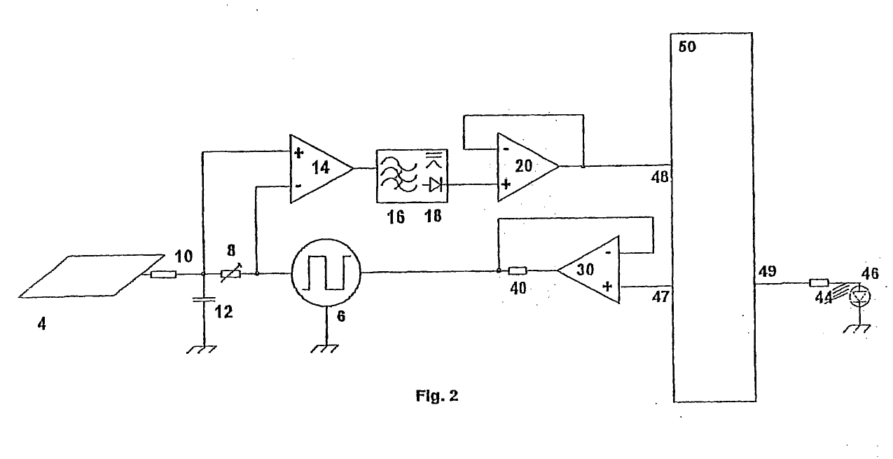

FIG. 2 shows a second embodiment of the capacitive detector which partly uses a microcomputer based architecture. It will function correspondingly to the capacitive detector described in FIG. 1 and will therefore not be described again. One advantage with this second embodiment is that the output indicating a change in the electric field around the antenna 4 can be divided up in several different levels. Thus the presence of an intruder can be divided into several zones of presence, for example a first zone indicating that an intruder is entering the electric field of the antenna 4 which could be indicated by a LED, a second zone indicating that the intruder can reach the antenna 4 which could be indicated with a summer and a third zone indicating that the intruder almost makes contact with the antenna 4 which could be indicated by an alarm.

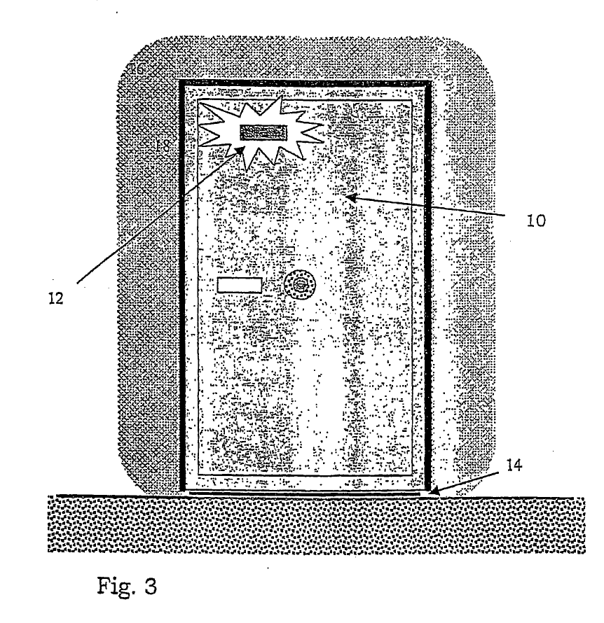

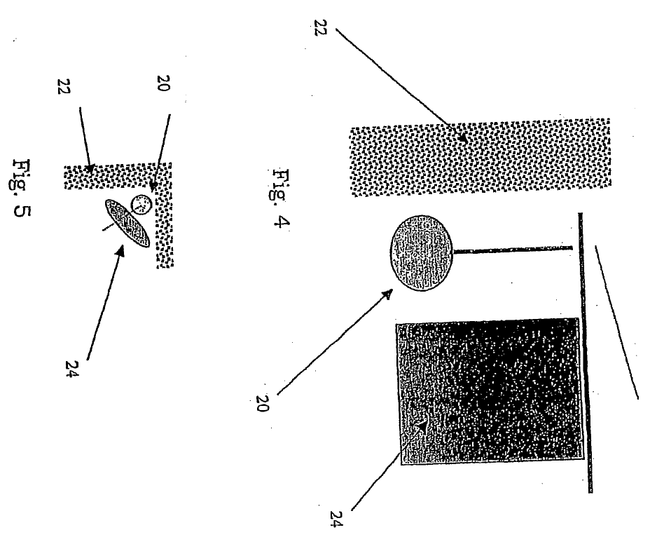

FIG. 3 shows the capacitive detector used in an alarm system for protecting a safe 10 from being attacked or removed. Here the electronic unit and capacitive detector 12 are arranged inside the safe to prevent access or manipulation thereof by an intruder. The housing of the safe is made of, or include, conductive material, and is used as an antenna whereby the electronic unit is connected to the housing via a signal cable. The safe is placed on an isolator 14, which functions as a second antenna, a reference antenna. The electronic unit generates two levels of protection; an outer level 16, which for example can generate a local sound alarm or a light, and a second level of protection 18, which for example generates an alarm signal via radio or alarm network. Any form of conductive object or human is detected when the protection levels are entered in order to manipulate the lock, break, drill, grind or weld through the housing.

The housing effectively protects the electronic unit from all forms of manipulation leading to a situation where it is necessary to force the housing in order to manipulate the electronic unit or otherwise the intruder will be detected, which means that the electronic unit has to be destroyed.

Attacks with non-conductive objects such as for example non-conductive sledge hammers, are detected in that the relation between any of the factors signal-/reference antenna or ground is altered. An example of such a device is shown in FIG. 4. It comprises a pendulum 20 or the like arranged hanging adjacent a side wall 22 of the housing. The pendulum is made of steel or iron and is connected to ground or alternatively an untreated oscillator signal of the electronic unit. A guide 24 is arranged adjacent the pendulum for urging it against the side walls of the housing during tilting or shaking of the safe. The pendulum may of course be replaced by other object, such as a spring, which is capable of being moved due to movement or tilting of the safe so that a contact is obtained. The contact means that the electronic unit reacts, leading to an indication like a loss of the antenna, i e a negative indication, if the pendulum is connected to an untreated oscillator signal, and a positive indication is the pendulum is connected to earth (of the same kind as detection of an attacker). It is of course conceivable to have some other kind of vibration sensor connected to the cable between the antenna (safe) and the detector device and capable of breaking the connection. This leads to a signal that the antenna is lost, thereby causing the detector device to issue an alarm signal.

If the protection field is extended to for example 30 cm and the safe is placed on a thin floor or against thin walls, the protection field will penetrate the walls and react on perfectly legal movements behind the wall. In order to prevent such false alarms, the untreated signal from the oscillator is used so that it shields off the signal from the housing of the safe. A conductive material is placed between the safe and the wall, which material is connected to oscillator so that the measuring signal cannot penetrate the wall and thus prevents unintentional influences behind the wall, i e prevents false alarms.

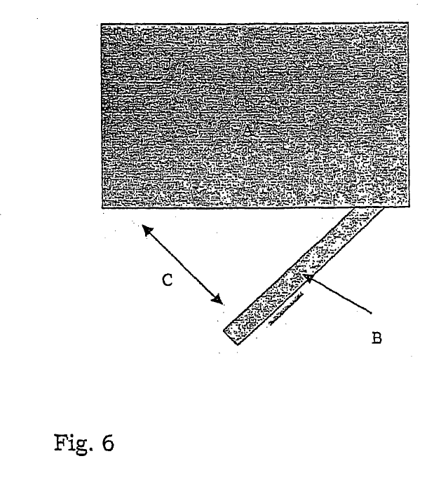

As can be seen from FIG. 6, the original antenna area is indicated with A, which creates a protection field of 30 cm. when the door is left open, an antenna area corresponding to B is added, which also generates a protection field of 30 cm the areas A and B thus create a resulting protection field of 60 cm at the point C. To that is added the synergetic effect of two cooperating antennas, which means a further propagation of the protection fields and thus prevents a conductive object from passing through the opening C.

The capacitive detector used in this embodiment is of the kind described in FIG. 2, i.e with a partly microcomputer based architecture, which enables the alarm system to operate with several zones of presence. The ranges that define the different presence zones are realized by software, which is within the competence of those skilled in the art.

As mentioned above, the safe is of a conductive material. It is to be understood that it could also be of a non-conductive material and with a layer of conductive material, such as a foil, plastic, paint or the like. Also, even if the preferred embodiment describes a safe, it could be any kind of container where one wishes to protect the its contents.

Accordingly, it is intended that the invention be limited not by the structural or functional elements described in the embodiment, but only as set out in the appended claims.

COMPONENT LIST

| Reference | Component |
|---|---|
| number | (value) |
| 8 | 0-10 k.OMEGA. |
| 10 | 3.3 k.OMEGA. |
| 12 | 47 pF |
| 14 | CA 3160 E |
| 20 | TL 074 |
| 22 | LM 339 |
| 24 | LM 339 |
| 26 | 1 M.OMEGA. |
| 30 | TL 074 |
| 33 | 2.84 volt |
| 36 | 1 M.OMEGA. |
| 38 | 100 μF |
| 40 | 200 .OMEGA. |

1. An alarm system for surveillance of a container (10) located within an electric or electromagnetic field surrounding said container, said alarm system comprising,
a detector device (2) arranged to said container, said detector device comprising, generating means (6) for generating an electric or electromagnetic field, balancing means (8, 10, 12) for building up a balanced electric or electromagnetic field, filtering means (16, 18) to prevent the detector device from being affected by chances in temperature and humidity,
characterised in that the container (10) includes conductive material and connected to said detector device so as to constitute an antenna (4) for sensing small capacitive changes in said electric or electromagnetic field, that the generating means and balancing means respectively generates and builds up an electric or electromagnetic field around said container, said generating means (6) being a square wave generator, the unaffected square wave from said generator means (6) and the square wave capacitively affected by the field surrounding the container (4) being fed to amplifier means (14) to amplify the difference thereof, and defining means for defining at least one level of protection.

2. An alarm system according to claim 1, characterised in that said defining means is capable of defining several levels of protection.

3. An alarm system according to claim 1 or 2, characterised in that said detector device is arranged inside said container.

4. An alarm system according to any of the preceding claims, characterised in directing means for directing said electric or electromagnetic field in predetermined directions around said container.

5. An alarm system according to claim 4, characterised in that said directing means includes a conductive material is arranged outside said container in predetermined locations, and in that said conductive material is connected to said detector device and fed with said unaffected square wave.

6. An alarm system according to any of the preceding claims, characterised in that it includes a vibration detector means connected to said detector device and arranged inside said container.

7. An alarm system according to any of the preceding claims, characterised in that said detector device is capable of detecting changes of the size of the container.

8. An alarm system according to claim 7, characterised in that an enlargement of the size of the container increases the antenna signal.

9. An alarm system according to any of the preceding claims, characterised in that said defining means comprises a microcomputer defining two levels of presence for an intruder depending of the value of the difference between the detected voltage and a reference voltage, wherein the first level generates a local sound alarm or light, and the second level generates an alarm signal via radio or alarm network.
